(19) United States
(12) Patent Application Publication
(10) Pub. No.: US 2013/0062882 A1
(43) Pub. Date: Mar. 14, 2013

(54) Power Sluice Gate System

(71) Applicant: Frank Vincent Zammataro, Chatham, NJ (US)

(72) Inventor: Frank Vincent Zammataro, Chatham, NJ (US)

(73) Assignee: RENTRICITY INC., New York, NY (US)

(21) Appl. No.: 13/232,044

(22) Filed: Sep. 14, 2011

(51) Int. Cl. F03B 13/08

(52) U.S. Cl. 290/52

(57) ABSTRACT

A power sluice gate system and method is disclosed. In one embodiment, the system a support structure, and a bracket assembly movably engaged with the support structure is provided. A turbine rotor supported by the movable bracket assembly can be selectively lowered into and raised out of a sluice discharge channel to allow waste water from a retention area to flow across the turbine rotor. A generator may be connected to the turbine rotor for transforming mechanical energy provided by the turbine rotor into electricity.

### FIELD OF THE INVENTION

This invention relates to the field of sluice gates and, more particularly to sluice gates used to regulate water flow at wastewater treatment plants.

### BACKGROUND OF THE INVENTION

At wastewater treatment facilities, treated water is delivered back to the environment. For example, various channels and weirs may be used to deliver treated water to a river, stream, or bay. Sluice gates are often employed to control the flow of water and/or water level through these channels.

Currently, wastewater treatment systems are large consumers of energy with approximately 3% of all U.S. power associated with water processing. As a result, there is currently great interest in increasing the energy efficiency of these treatment facilities. It has been identified that the flow of water through the channels and falling over the weirs present an opportunity to capture energy that may be used to augment the energy used at wastewater plants. Because sluice gates are positioned in a mouth of a channel, where the velocity of water is relatively high, it would be desirable to harvest energy from the flow of water passing under, or over sluice gates.

Therefore, there is a need for a sluice gate that can capture energy from the flow of water. There is also a need for a method of retrofitting existing sluice gates so that they can capture energy from water flow. These goals should be achieved while also providing the option to operate the waste water treatment facility without hindrance by a power generator so that water treatment operations are not impacted, especially during high-flow situations.

### SUMMARY OF THE INVENTION

An electricity generation system is provided. The system may include a support structure, and a bracket assembly movably engaged with the support structure. A waste water retention area may be in fluid communication with an open discharge channel. A movable gate may selectively hold waste water in and release waste water from the retention area. A turbine rotor supported by the movable bracket assembly can be selectively lowered into and raised out of the discharge channel to allow waste water from the retention area to flow across the turbine rotor when waste water from the retention area is flowing through the discharge channel. A generator may be connected to the turbine rotor for transforming mechanical energy provided by rotation of the turbine rotor into electricity. The generator may be selectively disconnected from the rotor to allow the rotor to be moved out of the discharge channel while the generator remains stationary.

A method of generating electricity is also provided. The method may include providing a support structure and a movable bracket assembly movably engaged with the support structure. The movable bracket assembly may support a turbine rotor, the rotor being mechanically connected to a generator. An open discharge channel may be provided. Raising a gate may allow waste water to flow in the open discharge channel. The bracket assembly may be lowered so that the turbine rotor is in waste water that is flowing through the open discharge channel from a waste water retention area. The turbine rotor may be allowed to rotate in response to the flowing waste water, which in turn causes the generator to generate electricity.

### BRIEF DESCRIPTION OF THE DRAWINGS

FIG. 1 is a perspective view of a system according to the present invention;

FIG. 2 is another perspective view of the system depicted in FIG. 1;

FIG. 3 is a perspective view of a second embodiment of the system according to the present invention;

FIG. 4 is a detailed view of a gearbox and generator according to the present invention;

FIG. 5 is a flow chart of a method that is in keeping with the invention;

FIG. 6 is a perspective view of a third embodiment of the system according to the present invention;

FIG. 7 is another perspective view of the system depicted in FIG. 6;

FIG. 8 is a detail view of a gearbox, clutch, and generator according to the present invention;

FIG. 9 is a perspective view of a fourth embodiment of the system according to the present invention;

FIG. 10 is another perspective view of the system depicted in FIG. 9;

FIG. 11 is another perspective view of the system depicted in FIG. 9;

FIG. 12 is another perspective view of the system depicted in FIG. 9;

FIG. 13 is a perspective view of a fifth embodiment of the system according to the present invention; and

FIG. 14 is another perspective view of the system depicted in FIG. 13.

### DETAILED DESCRIPTION OF THE INVENTION

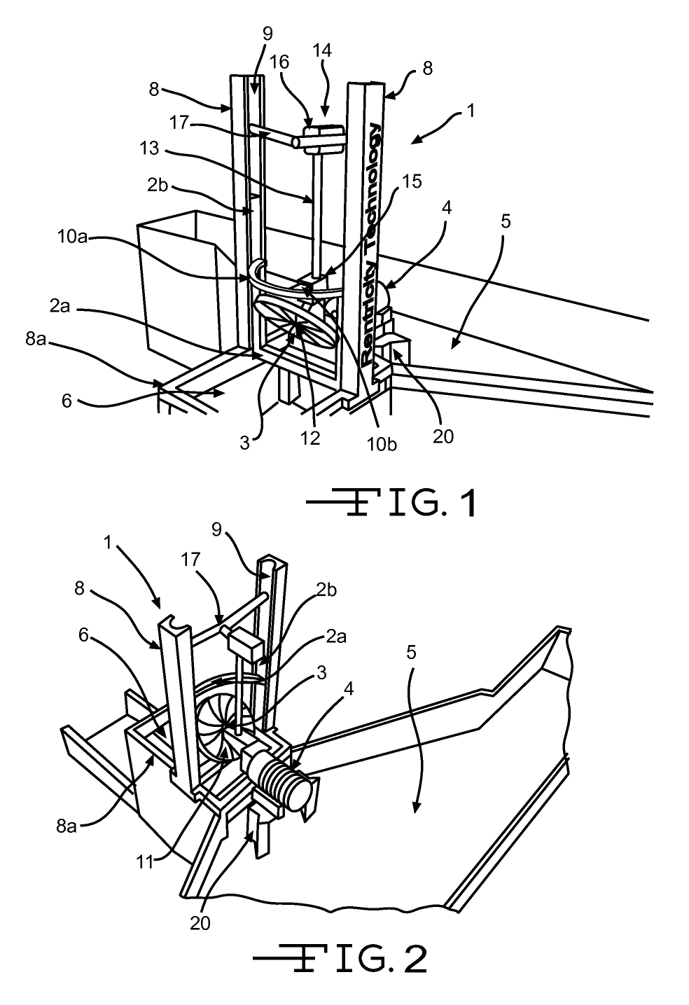

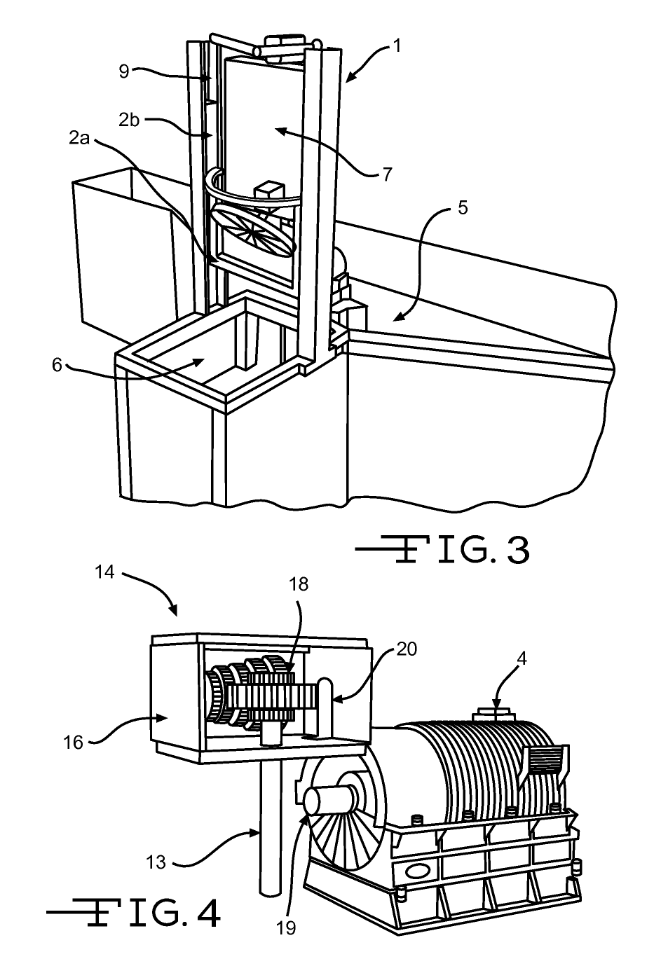

A system according to the invention may have a support structure 1, a bracket assembly 2a, a turbine 3, and a generator 4. FIGS. 1 and 2 depict one such system. The system may generally be located downstream of a wastewater retention area 5, for example, at an open discharge channel 6 which receives waste water from the retention area 5. The support structure 1 may be sized to fit the discharge channel 6. The support structure 1 may be bolted into an existing concrete discharge channel 6. The support structure 1 is described herein as being arranged for securement in or to the masonry of a sluice way, however, the support structure 1 may be arranged in any well known manner, as is usual in connection with sluice gate constructions. The support structure 1 may support the bracket assembly 2a and turbine 3. FIG. 3 depicts an embodiment of the system where the support structure supports a sluice gate 7. Alternatively, the support structure 1 may be placed adjacent to an existing support structure (not shown) for a sluice gate and thus the system may be retrofitted to an existing sluice gate facility. The support structure 1 can be composed of transversely spaced vertical side members 8, each having a track 9. Base structure 8a may support the vertical side members 8, or side members 8 may be integrally formed with a discharge channel (not shown). In the embodiment shown, base structure 8a forms a housing, which is configured to fit the discharge channel 6. The support structure 1 can have a cast iron frame and be sized to fit the channel 6. Some channels 6 at a wastewater retention facility are approximately 4′-5′ wide and approximately 4′-10′ deep. Although cast iron is a preferred material for the support structure 1 due to its low cost and durability, any suitable material may be used.

The system may include a movable bracket assembly 2a movably engaged with respect to the support structure 1. The bracket assembly may be slidable relative to the support structure 1 between lower and upper positions. The bracket assembly 2a may support a turbine rotor 3. The bracket assembly 2a may be slidably attached to sliding members 2b. Each track 9 may include one sliding member 2b. The bracket assembly 2a may include a semi-circular transverse member 10a to provide additional lateral support to the bracket assembly. The transverse member 10a may be slidably engaged with the sliding members 2b. As such, when the turbine 3 is raised or lowered, the sliding members 2b may slide within the tracks 9, and the bracket assembly 2a may slide on the sliding members 2b.

The bracket assembly 2a may have a lift system which includes a chain (not shown) that is attached to the bracket assembly 2a. In one embodiment, the chain may pass around a pulley (not shown) that is attached to the support structure 1 to realize a mechanical advantage, whereby the force necessary to raise or lower the bracket assembly is reduced. In this manner, the bracket assembly 2a may be raised or lowered by respectively pulling or releasing the chain. By lifting the bracket assembly 2a, the turbine rotor 3 may be moved away from the flow of water through the discharge channel 6. In this manner, the option may be provided to operate the waste water treatment facility without the turbine rotor 3 interfering with water flow, which may be helpful during high-flow situations.

The turbine 3 may be submersible, with a propeller or impeller 11 that is rotatably mounted about a hub or axle 12. In a first embodiment, the turbine 3 is a low head axial flow turbine, with stainless steel impellers having a diameter that is sized to fit the channel. FIG. 3 shows a gate 7 which may be used to control the velocity of water flowing across the turbine. In a preferred embodiment, the turbine 3 may be positioned at an angle relative to the sluice gate so that the impeller or propeller is positioned with respect to the flow of water to optimize efficiency. The angle of the turbine 3 may be adjusted prior to installing the system in order to achieve efficient operation given the expected water flow rate. It may be preferable to place the turbine 3 where the kinetic energy of the water flow is highest.

A drive shaft 13 may be vertically arranged to transfer energy from the turbine 3 to a gearbox 14. The drive shaft 13 may be configured to rotationally move with the turbine 3. Because the turbine 3 may be angled with respect to the drive shaft, a bevel gear (not shown) may be provided to transfer energy from the turbine to the drive shaft. A housing 15 may be provided to protect the bevel gear. The housing 15 may be connected to the transverse member 10a via a bridge element 10b, so that the bracket assembly 2a supports the turbine 3. See FIG. 1. Preferably, the shaft 13 is made of a weather-resistant and durable material, such as stainless steel, in order to resist corrosion arising from exposure to weather and the waste water. The drive shaft 13 may be approximately 2.5 to 3.5 feet long and have a cylindrical profile with a diameter corresponding to the turbine configuration. The shaft 13 rotates at a speed relative to the rotation of the turbine blades 11a.

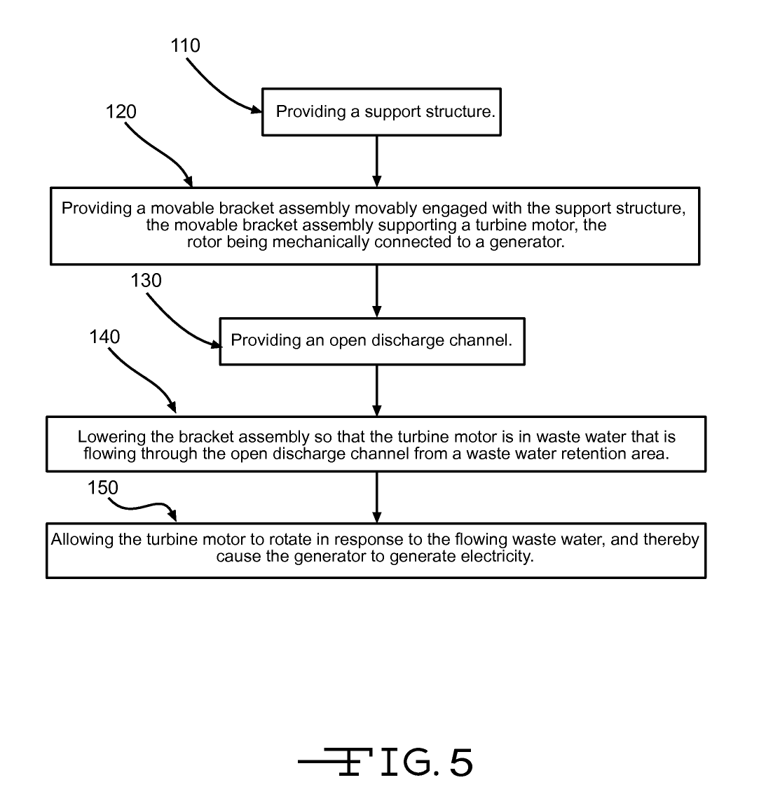

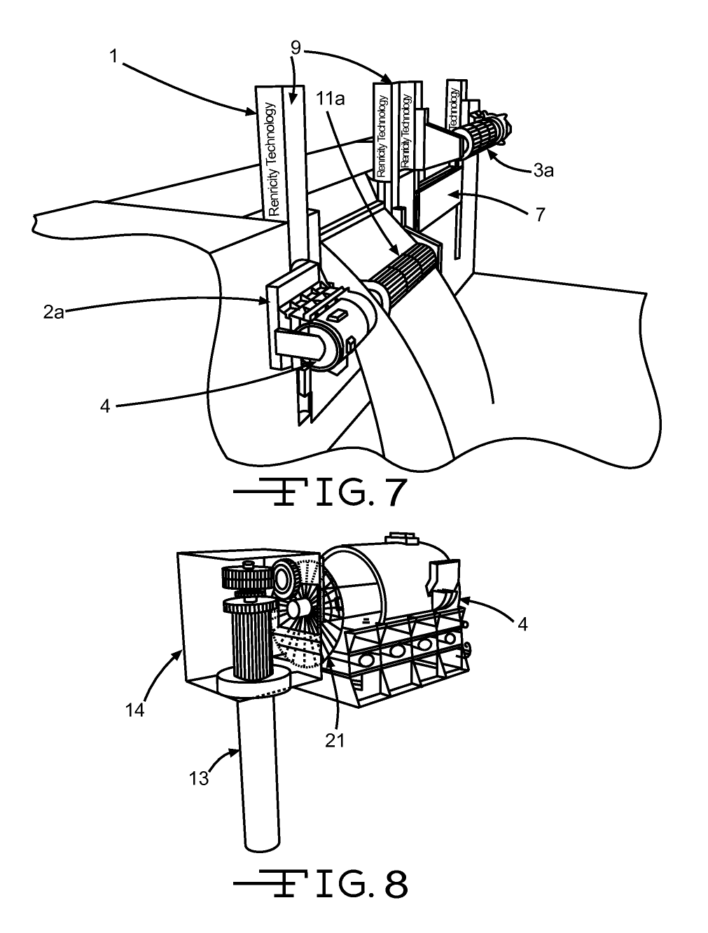

The gearbox 14 may couple the drive shaft 13 to the generator 4. In this manner, the drive shaft 13 and gearbox 14 may move vertically along with vertical movement of the turbine and bracket assembly. FIGS. 1 and 2 show that the gearbox may be supported by transverse member 17, which slides along tracks 9 as the bracket assembly 2a is raised and lowered. FIG. 4 shows a detailed exploded view of the gearbox 14. Gearbox 14 may include a housing 16 for containing gears 18 for transferring power from the drive shaft 13 to the generator 4. The gearbox 14 may be used to convert a slower, high-torque rotation received from the drive shaft 13 into a faster rotation for the generator 4. In the embodiment depicted, the gearbox 14 comprises bevel gears 18 to transfer the rotation of the drive shaft 13 to a generator shaft 19, which is positioned substantially orthogonal to the drive shaft 13. The gears 18 may be made of standard materials that are suitable for transferring power. It is desirable for the gearbox 14 to be relatively small, so as not to interfere with smooth operation of raising and lowering the bracket assembly, turbine, and drive shaft. The gearbox housing 16 may include a receiving slot 20 to receive the generator shaft 19 when the bracket assembly 2a is lowered. A clutch 21 (shown in FIG. 8) may be used to disengage the generator 4 from the gearbox 14, or the gearbox 14 from the drive shaft 13 (not shown).

The generator 4 may include the generator shaft 19 which is coupled to the gearbox 14. The generator shaft 19 may mate with the gearbox 14 when the bracket assembly 2a is lowered. The generator shaft 19 transfers rotational energy from the gearbox 14 to the generator 4, which causes the generator 4 to rotate and thereby generate electricity. The generator 4 may be placed in close proximity to the gearbox 14. In a preferred embodiment, the generator 4 is held by support 20 above water in the retention area 5, and therefore positioned upstream from the sluice gate. Placing the generator 4 upstream from the sluice gate may allow for raising and lowering of the rotor independently of the generator. The generator 4 is not limited to being placed upstream from the sluice gate, and may be placed beside the sluice gate, above the sluice gate, or downstream from the sluice gate.

FIG. 3 depicts an embodiment of the present invention having a standard vertically-movable sluice gate 7. The gate 7 may be positioned between the tracks 9 on the vertical side members 8 of the support structure 1 which receive rollers (not shown) affixed to the gate 7. The rollers may slide along the tracks 9 to allow the gate to be raised or lowered. The gate may be integrated into the support structure 1, or have its own support structure (not shown). Although the drive shaft 13 may pass through the gate 7 as shown in FIG. 3, it may be located in front of, or behind, gate 7.

At more sophisticated wastewater treatment installations, the industrial waste water treatment system may be monitored and controlled by an existing in-house Supervisory Control and Data Acquisition System (SCADA). At still other installations, control of the waste water treatment system may be effected by Programmable Logic Controllers (PLC) with a standalone user interface. Both PLC and SCADA systems generally have communication systems which allow them to either send data to other systems or computers, automatically, or when requested. Furthermore, PLC and SCADA systems may also provide for remote control and access operations, allowing outside users to connect via a variety of protocols, such as TCP/IP access. Remote access allows employees and operators of the treatment facility to monitor and control the treatment facility. It is contemplated that the system described in the present application may be controlled (e.g., raised and lowered) by a PLC or SCADA system.

FIG. 5 depicts a method of generating electricity. A support structure may be provided 110. A movable bracket assembly may be provided 120, the bracket assembly being movably engaged with the support structure, and the bracket assembly supporting a turbine rotor, the rotor being mechanically connected to a generator. An open discharge channel may be provided 130. The bracket assembly may be lowered 140 so that the turbine rotor is in waste water that is flowing through the open discharge channel from a waste water retention area. The turbine rotor may be allowed 150 to rotate in response to the flowing waste water, which in turn causes the generator to generate electricity. When it is desired to stop generating electricity, the bracket assembly is raised so that the turbine rotor is removed from the waste water that is flowing through the open discharge channel.

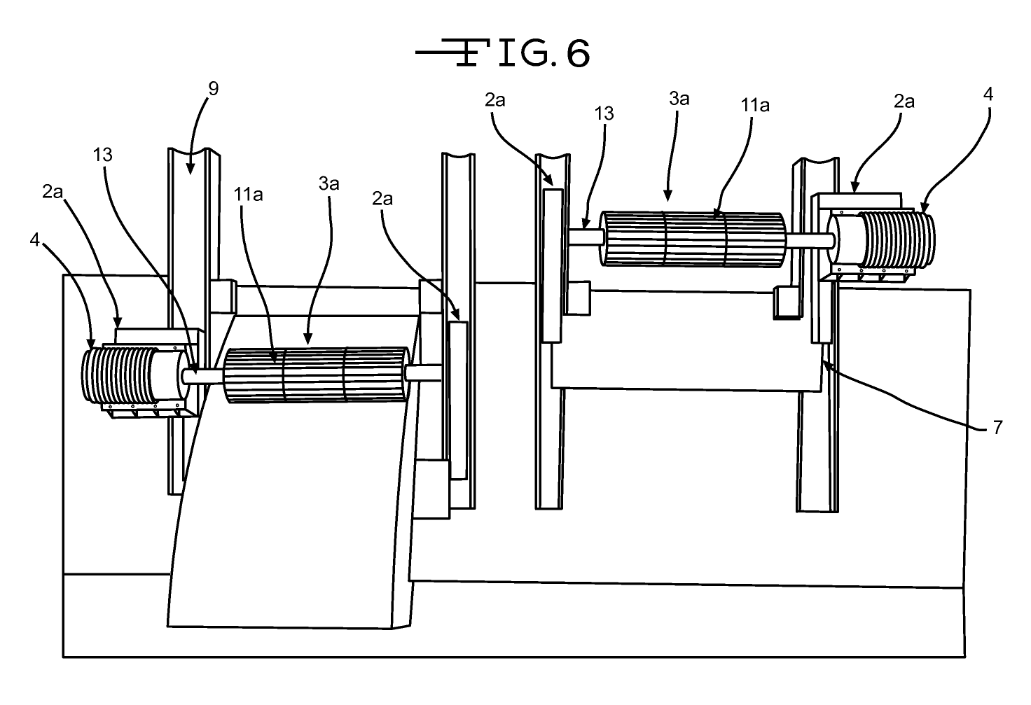

FIGS. 6 and 7 depict an embodiment where the turbine 3a is a cross-flow turbine, having turbine blades 11a that may be oriented so that water flowing through the open discharge channel 6 passes through the turbine 3a substantially transversely with respect to the axis of rotation. FIGS. 6 and 7 each show two turbines 3a, one in the lowered position (on left) and one in the raised position (on right). In this embodiment, the generator 4, drive shaft 13, and turbine 3a may slide along track set 9 of support structure 1. The generator 4, drive shaft 13, and gate 7 may be held by the bracket assembly 2a.

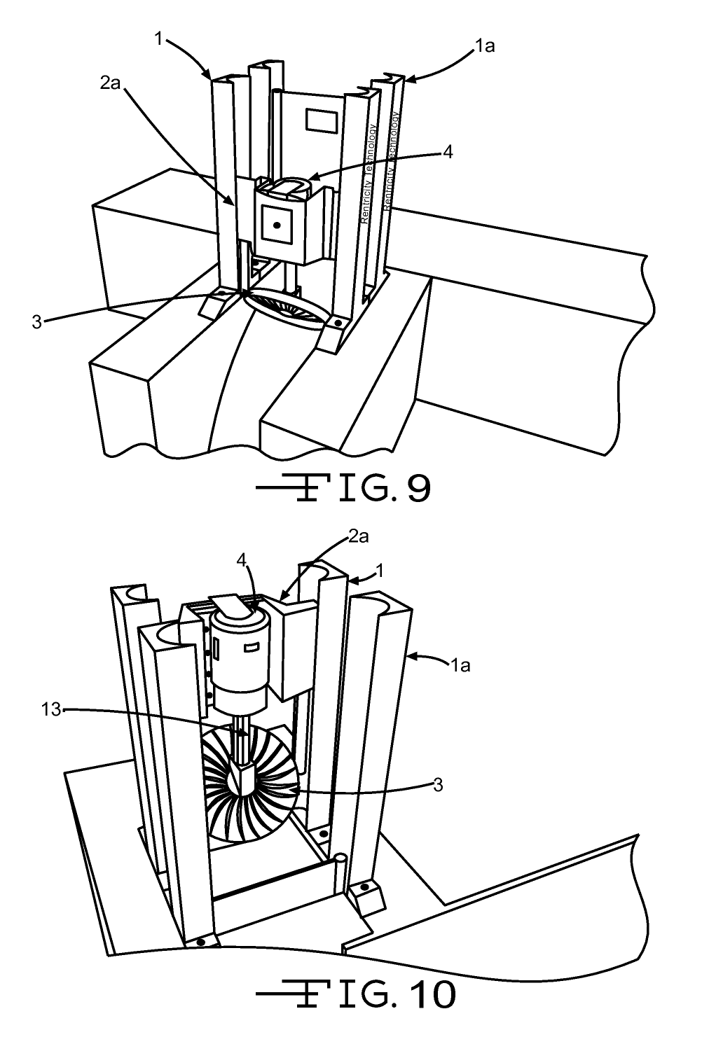

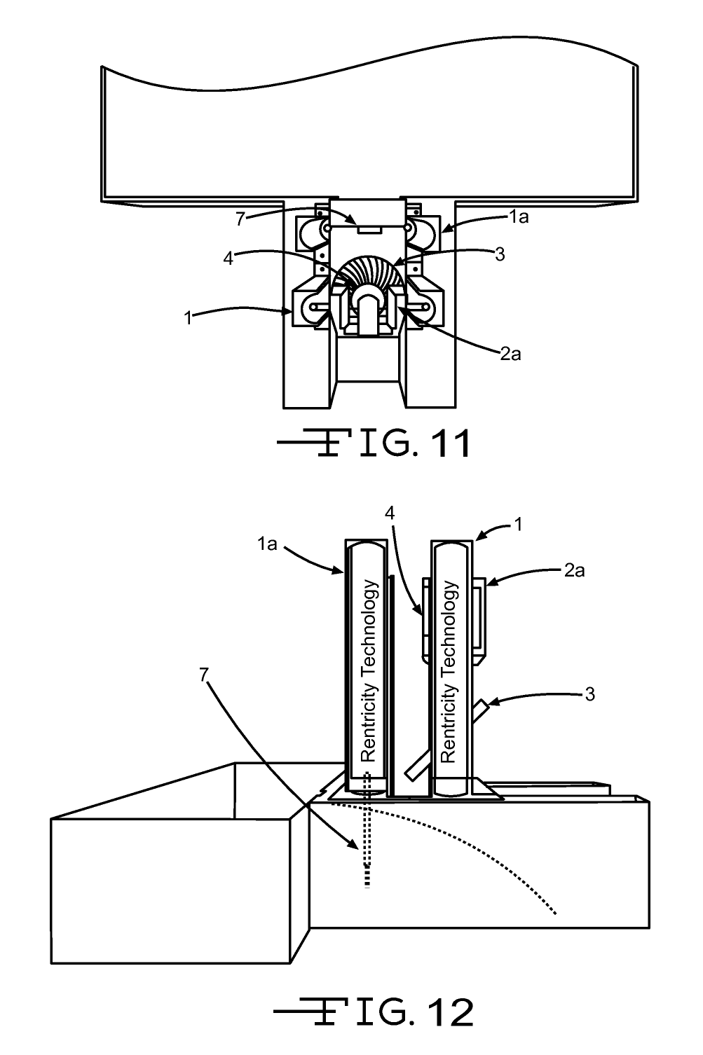

FIGS. 9-12 depict an embodiment where the support structure 1 may be placed adjacent to an existing support structure la for a sluice gate, and thus the system may be retrofitted to an existing sluice gate facility. In this embodiment, the drive shaft 13 may be connected directly to the generator 4, without a gear box or clutch. Additionally, the generator 4 may be held by the bracket assembly 2a so that the generator 4, drive shaft 13, and turbine 3 may be raised or lowered with the bracket assembly 2a.

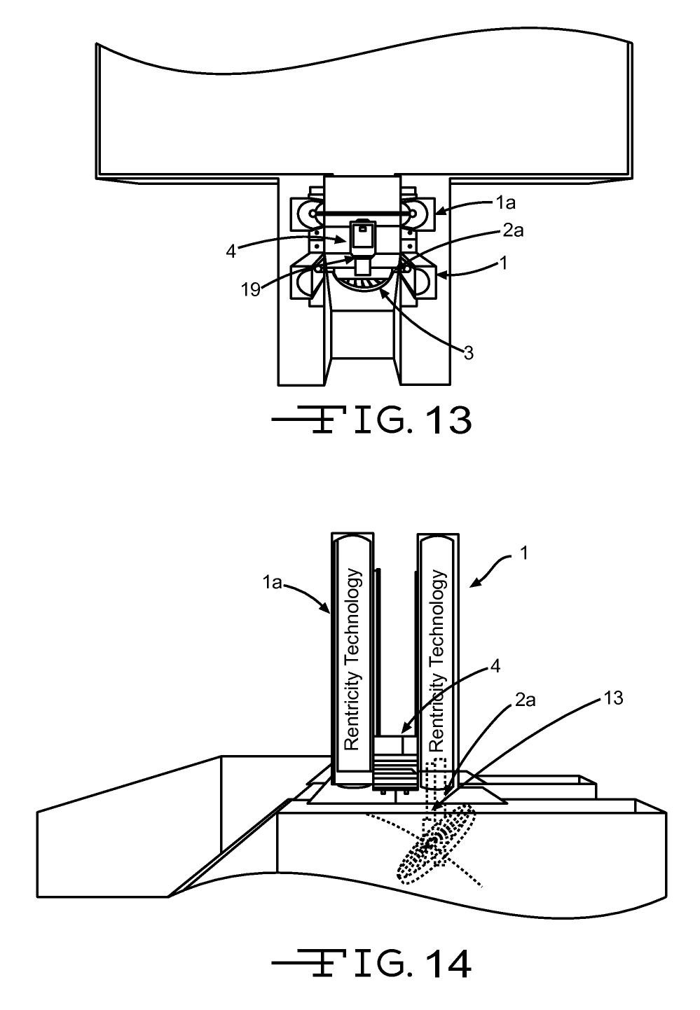

FIGS. 13 and 14 depict an embodiment where the generator 4 may be held by the bracket assembly 2a in a horizontal orientation so that the generator 4 may be placed approximately between an existing support structure 1a and support structure 1. In this embodiment, the drive shaft 13 may be at approximately a right angle relative to the generator shaft 19. Similar to the embodiment shown in FIGS. 9-12, in this embodiment the generator 4 may be held by the bracket assembly 2a so that the generator 4, drive shaft 13, and turbine 3 may be raised or lowered with the bracket assembly 2a.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. An electricity generation system, comprising:
a support structure;
a bracket assembly movably engaged with the support structure;
a waste water retention area;
an open discharge channel in fluid communication with the retention area;
a turbine rotor supported by the movable bracket assembly, wherein the turbine rotor can be selectively lowered into and raised out of the discharge channel to allow waste water from the retention area to flow across the turbine rotor when waste water is flowing from the retention area through the discharge channel; and
a generator selectively connected to the turbine rotor for transforming mechanical energy provided by the turbine rotor into electricity.

2. The electricity generation system of claim 1, further comprising a movable gate for selectively holding and releasing waste water in the retention area to the channel.

3. The electricity generation system of claim 2, wherein the generator is placed upstream of the movable gate.

4. The electricity generation system of claim 1, further comprising a gearbox having an aperture, the aperture for receiving a generator shaft from the generator when the turbine rotor is selectively lowered into the discharge channel.

5. The electricity generation system of claim 1, wherein the support structure includes at least one rail.

6. The electricity generation system of claim 1, wherein the support structure includes a flow control valve configured to allow control of the velocity of the waste water flowing across the turbine rotor.

7. The electricity generation system of claim 1, further comprising a lift system attached to the bracket assembly, the lift system being able to selectively raise and lower the bracket assembly, and thereby the turbine rotor.

8. The electricity generation system of claim 7, wherein the lift system includes a chain connected to the bracket assembly, and a pulley about which the chain moves.

9. The electricity generation system of claim 1, further comprising a drive shaft, a coupling, and a gear set for transmitting mechanical motion of the turbine rotor to the generator.

10. The electricity generation system of claim 9, further comprising a means for selectively disconnecting the turbine rotor from the gear set.

11. The electricity generation system of claim 10, wherein the means for disconnecting is a clutch.

12. The electricity generation system of claim 1, wherein the open discharge channel includes an outlet spillway into which the rotor may be selectively lowered.

13. The electricity generation system of claim 12, wherein the support structure is attached to a discharge chamber that is proximate to the movable gate and at least partially surrounds the outlet spillway.

14. The electricity generation system of claim 1, wherein the open discharge channel is approximately level at a location where the rotor is selectively lowered into the discharge channel.

15. The electricity generation system of claim 1, wherein the open discharge channel extends from the waste water retention area to another waste water retention area.

16. The electricity generation system of claim 1, further comprising an electrical control and protection system that monitors characteristics of the power produced by the generator and transmits the electricity to a power distribution system.

17. The electricity generation system of claim 16, wherein the electrical control and protection system includes at least one protective relay, at least one programmable logic controller to provide continuous data on a selected system parameters, programmable software coded to cause specific actions to occur, and at least one electrical interrupt assembly.

18. The electricity generation system of claim 16, wherein the electrical control and protection system includes controllers and software interfaced with a waste water treatment plant's supervisory control and data acquisition system.

19. The electricity generation system of claim 1, wherein the waste water is effluent from a waste water treatment location.

20. A method of generating electricity, comprising:
providing a support structure;
providing a movable bracket assembly movably engaged with the support structure, the movable bracket assembly supporting a turbine rotor, the rotor being mechanically connected to a generator;
providing an open discharge channel;
lowering the bracket assembly so that the turbine rotor is in waste water that is flowing through the open discharge channel from a waste water retention area; and
allowing the turbine rotor to rotate in response to the flowing waste water, and thereby cause the generator to generate electricity.

21. The method of claim 21, comprising raising a gate to allow waste water to flow in the open discharge channel.

21. The method of claim 20, comprising maintaining operational flow by raising the bracket assembly so that the turbine rotor is out of the waste water that is flowing.

22. The method of claim 21, comprising controlling the velocity of the waste water flowing across the turbine rotor by adjusting the gate.

23. The method of claim 20, wherein the bracket assembly is lowered by a lift system attached to the bracket assembly.

24. The method of claim 20, wherein lowering the bracket assembly positions a gearbox to couple with the generator.

25. The method of claim 20, comprising positioning the generator upstream of the gate.
